(19) United States
(12) Patent Application Publication
(10) Pub. No.: US 2025/0170860 A1
(43) Pub. Date: May 29, 2025

(54) TIRE CAVITY RESONANCE NOISE ABSORBER

(71) Applicant: Bridgestone Europe NV/SA [BE/BE], Zaventem (BE)

(72) Inventors: Robin Frank Arends, Roma (IT); Maria Del Mar Bernal Ortega, Roma (IT); Marco Emiliani, Roma (IT)

(21) Appl. No.: 18/836,443

(22) PCT Filed: Feb. 9, 2023
(86) PCT No.: PCT/EP2023/053166

§ 371 Date: Aug. 7, 2024

(30) Foreign Application Priority Data
Feb. 10, 2022 (EP) 22156178.0

(51) Int. Cl. B60C 19/00

(52) U.S. Cl. CPC B60C 19/002

(57) ABSTRACT

A tire as disclosed herein comprises: a tread portion; a bead portion; and a sidewall portion extending between the bead portion and the tread portion. The tread portion, bead portion and sidewall portion define an inner cavity of the tire. The tire further comprises a sealant layer arranged on the tread portion of the tire in the inner cavity of the tire; and a silicone foam noise reduction layer arranged on the sealant layer in the inner cavity of the tire.

### FIELD

The present disclosure relates to the improvement of noise reduction and self-sealing in tires.

### BACKGROUND

Tires are used on a range of different vehicles under a range of different conditions. Under some operating conditions, tires may generate undesirable levels of noise, which can negatively impact the experience of the driver or passengers. A noise absorbing, or reduction, layer may be installed on the inside of a tire with the aim of reducing tire noise.

Some tires include a sealant layer designed to automatically seal punctures to the tire. Such tires may be referred to as “self-sealing” tires. The sealant layer may be a viscous coating on the inside of the tire. The purpose of the sealant layer is to maintain the integrity of the tire in the event of a puncture, even when the puncturing object becomes dislodged from the tire.

It has not been possible to provide a self-sealing tire with good noise absorption properties without prejudicing the sealing performance. The use of noise reduction layers with sealant layers poses a number of issues. The noise reduction layer can become stuck to the sealant layer, deforming the noise reduction layer and impeding its performance. This can occur, for example, if the tire is impacted and forced to deform, thus compressing the noise reduction layer into the sealant layer.

Similarly, the noise reduction layer can become stuck to the sealant layer and prevent the sealant layer from flowing so as to seal a puncture. This can occur if a part of the noise reduction layer blocks the passage of the sealant layer into the puncture. Small parts of the noise reduction layer can become separated from the rest of the noise reduction layer and can be drawn into the puncture and prevent the sealant layer from sealing the puncture.

### SUMMARY

It has been found that tires according to the present disclosure overcome the disadvantages associated with the prior art. Tires according to the disclosure provide improved noise reduction performance, without prejudicing self-sealing performance. Tires as described herein achieve improved noise reduction and sealing performance without the need for increased complexity of the internal design of the tire cavity.

According to the disclosure is a tire. The tire may comprise a tread portion, a bead portion and a sidewall portion. The sidewall portion may extend between the bead portion and the tread portion. The tread portion, bead portion and sidewall portion may define an inner cavity of the tire. The tire may further comprise a sealant layer arranged on the tread portion of the tire in the inner cavity of the tire. The tire may further comprise a silicone foam noise reduction layer arranged on the sealant layer in the inner cavity of the tire.

The tire may be a pneumatic tire such as those used on vehicles including cars, light goods vehicles and heavy goods vehicles. The tire may be for mounting on a hub and filling with pressurised air. The bead portion may be at the radially-innermost side of the tire. The bead portion may be configured to provide rigidity to the tire and allow its mounting on a wheel hub. The tread portion may comprise a tread on its outer surface for engaging a road surface and providing grip. The sidewall portion may comprise two sidewall portions on opposing sides of the tread and extending between the tread portion and the bead portion.

The tire may be a self-sealing tire. The tire may be configured to automatically seal punctures. The sealant layer may be configured to provide this self-sealing ability. The sealant layer may be configured to automatically seal punctures through the tread portion—for example punctures in the range of 0 to 5 mm in diameter.

The sealant layer may comprise or consist of a viscous fluid configured to flow into a puncture or perforation in the tread portion and act to seal the puncture or perforation to prevent air loss through the puncture or perforation.

The sealant layer may be a homogeneous layer. The sealant layer may be formed of a single homogeneous composition. It may be configured to adhere (e.g. directly) to the tread portion and noise reduction layer.

The sealant layer may be in direct contact with the tire tread portion and the silicone foam noise reduction layer.

The sealant layer may be sandwiched between the tread portion and the silicone foam noise reduction layer without intermediary.

The tire may not comprise a separate adhesive layer, for example in addition to the sealant layer and the silicone foam noise reduction layer.

The tire may comprise only the sealant layer and silicone foam noise reduction layer in the inner cavity of the tire.

This arrangement of the sealant layer and noise reduction layer eliminates the need for a separate adhesive or supporting layer and greatly simplifies the structure of the tire.

The sealant layer may have a viscosity of between 50-1000 Pa*s (Pascal-seconds (Nsm⁻²)) at 100° C. The sealant layer may have a viscosity greater than 50, 100, 200, 400, 600 or 800 Pa*s; and/or the sealant layer may have a viscosity less than 1000, 800, 600, 400, 200 or 100 Pa*s at 100° C.

The viscosity being measured according to ASTM D5099.

The sealant layer may have a layer thickness of between 1 and 6 mm. The sealant layer may have a thickness greater than 1 mm, 2 mm, 3 mm, 4 mm or 5 mm; and/or the sealant layer may have a thickness less than 6 mm, 5 mm, 4 mm, 3 mm or 2 mm.

The sealant layer may have a tackiness of 0.1 to 25 N. The sealant layer may have a tackiness greater than 0.1, 2, 5, 10, 15 or 20 N; and/or the sealant layer may have a tackiness less than 25, 20, 15, 10, 5, 2 or 0.1 N.

The tackiness being measured with the Probe Tack Test with a plunger diameter between 25 and 30 mm and a probe with 30 mm diameter, a pre-load of 0.5 N, a dwell time of 30 seconds and a detachment speed of 2000 mm/min.

The sealant layer may comprise or consist of a rubber-based material. The sealant layer may be a compound sealant layer.

The sealant layer may comprise, or consist of, a butyl rubber (i.e. any butylic rubber), a plasticizer and a tackifier resin. The butyl rubber may be a halobutyl rubber.

The sealant layer may comprise a butyl rubber. The sealant layer may comprise 100 to 400 PHR of a plasticizer (PHR meaning parts per hundred parts of rubber). The sealant layer may comprise 10 to 80 PHR of a tackifier resin.

The sealant layer may comprise or consist of butyl rubber, 100 to 400 PHR of a plasticizer and 10 to 80 PHR of a tackifier resin.

The term PHR refers to the proportion of constituents with reference to 100 parts of rubber. For example, 50 PHR of a component requires 50 parts of that component for every 100 parts rubber. The PHR may be based on weight or volume.

During use, as the road surface impacts the tread portion of the tire, the air inside the cavity and/or the tire itself may be caused to vibrate. In tires without a noise reduction layer, this vibration may transfer to the interior of the vehicle as noise. This noise may typically be in the frequency band of 200 to 250 Hz. For tires of rim diameter higher than 19 inch the frequency band may shift to frequencies below 200 Hz like 170 to 220 Hz or 160 to 210 Hz.

The tire has a noise reduction layer. The noise reduction layer is a silicone foam noise reduction layer.

Surprisingly, it has been found that the use of a silicone foam for a noise reduction layer overcomes the disadvantages associated with existing arrangements using PU (polyurethane) or EPDM (ethylene propylene diene monomer) foams. A silicone foam noise reduction layer provides good noise adsorption while allowing the proper functioning of the sealant due to its low tackiness.

The silicone foam noise reduction layer is a cellular silicone foam with an open cell structure. The use of an open cell structure improves adhesion of the noise reduction layer to the sealant layer.

The use of an open cell structure allows mechanical adhesion to take place—that is, the sealant may infiltrate the open-cell structure of the silicone foam, holding the silicone foam in place within the tire. This may be achieved without significant adhesion of the sealant to the surface of the silicone foam itself—that is, the silicone foam may not prevent the sealant from flowing, and thus the sealant may be free to flow into a puncture to perform its sealing function.

The silicone foam noise reduction layer may have a range of operating temperatures from −40° C. to over 150° C. This may be as measured according to the ASTM D 1056 standard.

The silicone foam noise reduction layer may have a density of less than 105 kg/m³. The silicone foam noise reduction layer may have a density of less than 60 kg/m³. This may be measured according to the ASTM D 1056 standard.

The silicone foam noise reduction layer may have a tensile strength of greater than 70 kPa. This may be measured according to the ASTM D 412 standard.

The silicone foam noise reduction layer may have an ultimate elongation of greater than 40%. This may be measured according to the ASTM D 412 standard.

The silicone foam noise reduction layer may have a compression set of less than 5%. The silicone foam noise reduction layer may have a compression set of less than 2%. This may be measured according to the ASTM D 1056 standard.

The silicone foam noise reduction layer may have a temperature resistance of −40 to +150° C. The silicone foam noise reduction layer may have a temperature resistance of −40 to +100° C. This may be measured according to the ASTM D 1056 standard.

The silicone foam noise reduction layer may have a width of 50 to 150 mm. The width may be measured in a direction parallel to the axis of rotation of the tire.

The silicone foam noise reduction layer may have a thickness of 15 to 40 mm, 15 to 30 mm, 20 to 35 mm or 25 to 30 mm. The thickness may extend in a radial direction of the tire.

The silicone foam noise reduction layer may extend over 80 to 100% or 90 to 100% of the tire inner circumference.

The silicone foam noise reduction layer may be cuboidal. The silicone foam noise reduction layer may have a triangular or trapezoidal cross-section. The silicone foam noise reduction layer may be tapered. The silicone foam noise reduction layer may have a varying width or thickness around the circumference of the tire. The silicone foam noise reduction layer may have an undulating thickness or width around the circumference of the tire.

The silicone foam noise reduction layer may located centrally on the sealant layer. The silicone foam noise reduction layer may be located centrally and symmetrically about the central plane of the tire. This may improve the balance of the tire.

Further according to the disclosure is a vehicle comprising a tire as described herein.

### DETAILED DESCRIPTION

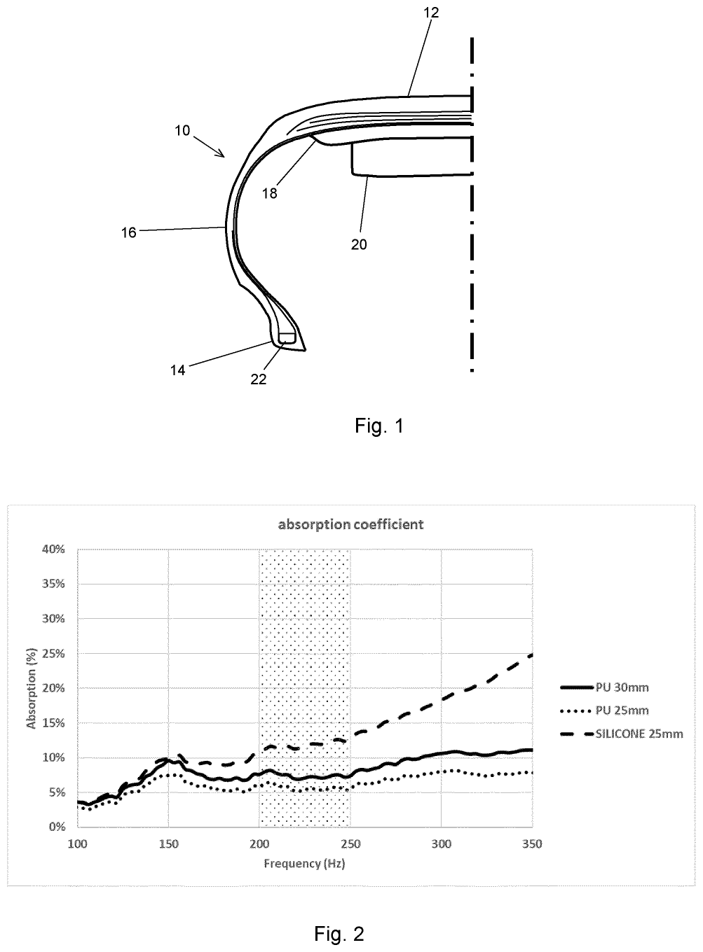

FIG. 1 is a partial cross-sectional view of a tire with a sealant layer and a silicone foam noise reduction layer; and

FIG. 2 is a graph showing the noise absorption performance of tires over a range of frequencies.

Turning now to FIG. 1, a cross-section of a tire 10 is shown. The tire 10 is a pneumatic tire of the type used on cars and other vehicles. FIG. 1 is a partial cross-sectional view, showing one side of the tire 10.

The tire 10 comprises a tread portion 12 arranged to engage a road surface. The tread portion 12 is arranged at the outer radial side of the tire 10. The tire 10 also comprises a bead portion 14. The bead portion 14 is arranged at an inner radial side of the tire 10. The bead portion 14 is arranged to connect the tire to a hub or wheel (not shown). The tire 10 also comprises a sidewall portion 16. The sidewall portion 16 extends between, and connects, the tread portion 12 and the bead portion 14. The tread portion 12, bead portion 14 and sidewall portion 16 collectively define an inner cavity of the tire 10. The cavity of the tire is pressurised during use.

The tread portion 12 comprises tread designed to engage and grip a road surface during use. A sealant layer 18 is arranged on an inner surface of the tread portion 12. The sealant layer 18 is arranged to cover at least a portion, or in some cases substantially the entire, inner surface of the tread 12. The sealant layer 18 is configured to repair damage caused to the tread 12 during use, for example by punctures.

The sealant layer 18 achieves this due to the physical properties of the layer, which has a viscosity and tackiness such that it is able to flow into a puncture or perforation in the tread 12 and seal the puncture to prevent loss of pressure in the tire 10. The sealant layer 18 can act to seal punctures up to 5 mm, even once the object puncturing the tire is dislodged.

The sealant used to form the sealant layer 18 has tack properties that guarantees adhesion to both the inside of the tread portion 12 of the tire 10 and the noise reduction layer 20, without the need for an additional adhesive layer. This means there are only two layers, not three, on the inside of the tire tread 12.

Example properties of a sealant material suitable for use as a sealant layer providing adequate sealing performance are shown in Table 1 below.

TABLE 1

| | Viscosity (Pa*s) | Layer thickness | |
|---|---|---|---|
| | at 100° C. | (mm) | Tackiness (N) |
| Sealant | 50-1000 | 1-6 | 0.1-25 |

In some examples the tackiness may be between 5 and 20 N.

The bead portion 14 comprises a strengthening member 22 located inside a cavity formed in the bead portion 14, for example to provide strength and rigidity to the tire 10.

The sidewall portion 16 comprises a sidewall on either side of the tire 10.

The tire 10 further includes a noise reduction layer 20. The noise reduction layer 20 is located on the sealant layer 18 such that the sealant layer 18 is sandwiched between the tread portion 12 and the noise reduction layer 20. In the present example, the noise reduction layer 20 is located centrally with respect to the centre-plane of the tire 10—this has been found to improve the balance and rotational stability of the tire 10. In the example of FIG. 1, the noise reduction layer 20 extends over the majority of the sealant layer 18 (e.g. in a direction parallel to the axis of rotation of the tire and/or the circumferential direction). In other examples, the noise reduction layer 20 may extend over the entire sealant layer 18 or extend over a smaller fraction of the sealant layer 18.

In the present examples, a substantially cuboidal noise reduction layer 20 is used. Such an arrangement may be convenient as it may allow the noise reduction layer 20 to be produced and transported in rolls. However, in other examples alternative geometries of noise reduction layer may be employed. For example, the noise reduction layer may have a triangular or trapezoidal cross-section, or may comprise surface undulations or variations in thickness parallel to the radius of the tire.

The noise reduction layer 20 is configured to absorb vibrations of the tire 10 during use and thereby damp vibrational noise of the tire 10. This noise is generated by air in the tire 10 being vibrated by an external input, such as the road surface contacting and deforming the tread portion 12 of the tire. Typically called tire cavity noise, the majority of this excitation and noise is within the frequency band of 200 Hz to 250 Hz.

In the present examples the noise reduction layer 20 is made of a silicone foam. Silicone foam has low sticking properties while also having good noise reduction characteristics. This means that silicone foam provides good noise absorption properties and, critically, does not interfere with the sealing properties of the sealant layer. As such, the use of silicone foam provides a tire 10 with both good self-sealing and noise reduction performance.

The example of FIG. 1 uses an open cell silicone foam as the noise reduction layer 20. The use of an open cell silicone foam allows the sealant material to penetrate inside the open cell structure of the silicone foam and thus achieve “mechanical adhesion”, wherein the silicone foam is locked to the sealant due to the infiltration of the sealant within the foam structure. This can improve overall adhesion in both the lateral and radial directions, without the sealant adhering to surfaces of the foam per se. This minimises movement of the foam, even during large deformations of the tire 10. However, the sealant is still free to flow with respect to the silicone foam and, as such, sealing properties are largely unaffected.

A low density silicone foam is used and this reduces the overall weight of the tire.

Sealing tests were conducted on tires with sealant only, sealant with a PU foam noise reduction layer and sealant with a silicone foam noise reduction layer and the results are shown in Table 2 below.

Test Conditions were as Follows for the Indoor Test:

Tire size: 215/65 R17; inflation pressure 2.5 bar; test speed 100 km/h; tire load 500 kg; test drum diameter 2 m; test room temperature 38° C.

Test Conditions were as Follows for the Outdoor Test:

Tire size: a.) 215/65 R17 and b.) 235/55 R19; inflation pressure 2.5 bar; test speed 100 km/h; tire load 500 kg; test vehicle VW Tiguan or equivalent in same compact SUV segment; ambient temperature range 1 between −25° C. and −5° C. (tested with tire size a.)) and ambient temperature range 2 between 20° C. and 40° C. (tested with tire size b.)).

The criteria for passing the tests was a minimum remaining inflation pressure of 1.8 bar in the tire after 1000 km of running with nails in the tread and then after removal of the nails running additional 400 km and 14 days of storage. As can be seen, the use of a silicone foam noise reduction layer results in good sealing performance, whereas the use of a PU foam noise reduction layer does not. The reason for this is that the PU foam noise reduction layer suffers from the disadvantages discussed herein—namely it can interfere with the operation of the sealant layer and thereby prevent adequate sealing properties. The silicone foam noise reduction layer, however, does not interfere with the performance of the sealant layer.

TABLE 2

| | Indoor sealing | | | | | |
|---|---|---|---|---|---|---|
| | test (on drum) | | | Outdoor sealing tests | | |
| | | Sealant | Sealant | | Sealant | Sealant |
| | | & | & | | & | & |
| | Sealant | PU | Silicone | Sealant | PU | Silicone |
| | only | foam | foam | only | foam | foam |
| 6 × Nail 5 mm | Pass | Fail | Pass | Pass | Fail | Pass |
| 6 × Nail 4 mm | N/A | N/A | N/A | Pass | Fail | Pass |
| 6 × Nail 3 mm | N/A | N/A | N/A | Pass | Fail | Pass |

Turning now to FIG. 2 and Table 3 below, the absorption (i.e. the absorption coefficient or absorption rate) of the use of a 25 mm thick silicone foam noise reduction layer is compared to a similar 25 mm and 30 mm PU foam noise reduction layer of the same diameter. FIG. 2 plots the noise absorption rates over the frequency range 100 to 350 Hz for the three noise reduction layers. Table 3 below shows representative values of the noise reduction over the range of 200 to 250 Hz—which is the main frequency range for noise caused by tire cavity vibrations. It can be seen that the silicone foam noise reduction layer not only outperforms a PU noise reduction layer with corresponding dimensions, but also a larger PU noise reduction layer.

The absorption is measured according to ISO 10534-2.

TABLE 3
Absorption 200 Hz~250 Hz

| PU | PU | Silicone |
|---|---|---|
| 25 mm | 30 mm | 25 mm |
| 5.8% | 7.4% | 10.5% |

Table 4 sets out the noise level difference in decibels during an outdoor road test. Said outdoor road test is a so-called in-vehicle noise test performed driving at constant speed on rough road with a vehicle in the compact SUV segment; indicated values in dB(A) are arithmetically averaged values between measurements of microphones positioned at driver's left ear and front passenger's right ear; test tire size was 235/55 R19.

The results for a silicone foam noise reduction layer having a 25 mm thickness are compared to those of a corresponding tire with a 30 mm PU foam noise reduction layer. The results are shown as reductions in decibel levels with respect to an identical tire without any foam noise reduction layer. As can be seen, a silicone foam noise absorption layer is significantly more effective than a PU foam noise absorption layer.

TABLE 4
Noise level 200 Hz~250 Hz

| | | PU foam | SILICONE foam |
|---|---|---|---|
| | No foam | 30 mm | 25 mm |
| AVERAGE | Control | −1.2 dB(A) | −1.7 dB(A) |
| (50 km/h~80 km/h) | | | |
| 50 km/h | Control | −1.7 dB(A) | −2.5 dB(A) |
| 80 km/h | Control | −0.8 dB(A) | −0.9 dB(A) |

The increased performance of a silicone foam noise reduction layer opens the door to the reduction in noise reduction layer thicknesses in tires.

Silicone foam suitable for use as noise reduction layers may have a wide range of operating temperatures (e.g. from −40 to +100° C. or +150° C.). The silicone foam may also have a low compression set value, for example less than 5%, or more preferably less than 2%.

An example silicone foam suitable for use in the silicone foam noise reduction layer is the Rogers® MF1-35@.

Suitable properties of a silicone foam for use as a silicone foam noise reduction layer are provided in Table 5.

TABLE 5

| Property | Test method | Value |
|---|---|---|
| Foam type | — | Silicone Foam open cells |
| Density [kg/m3] | ASTM D 1056 | <105, (preferably <60 kg/m3) |
| Tensile Strength [kPa] | ASTM D 412 | >70 |
| Ultimate elongation [%] | ASTM D 412 | >40% |
| Compression Set (%) | ASTM D 1056 | <5%(preferably <2%) |
| Temperature resistance | ASTM D 1056 | −40 to +200 deg. Celsius |
| Format in tire: | — | Width: 100-150 mm |
| | | Thickness: 25-30 mm |
| | | 90%-100% Length tire inner |
| | | circumference |

The indicated values of compression set provide a material which can revert to its initial shape after being compressed by a load. This is good, as it allows the silicone foam to largely revert to its initial thickness and shape after deformation.

The present invention has been described above purely by way of example. Modifications in detail may be made to the present invention within the scope of the claims as appended hereto. Furthermore, it will be understood that the invention is in no way to be limited to the combination of features shown in the examples described herein. Features disclosed in relation to one example can be combined with features disclosed in relation to a further example.

1-15. (canceled)

16. A tire comprising:
a tread portion;
a bead portion; and
a sidewall portion extending between the bead portion and the tread portion, wherein the tread portion, bead portion, and sidewall portion define an inner cavity of the tire;
a sealant layer arranged on the tread portion of the tire in the inner cavity of the tire; and
a silicone foam noise reduction layer arranged on the sealant layer in the inner cavity of the tire.

17. The tire of claim 16, wherein the silicone foam noise reduction layer is a cellular silicone foam with an open cell structure.

18. The tire of claim 16, wherein the silicone foam noise reduction layer has a range of operating temperatures from −40° C. to over 150° C.

19. The tire of claim 16, wherein the silicone foam noise reduction layer has:
a density of less than 105 kg/m³;
a tensile strength of greater than 70 kPa;
an ultimate elongation of greater than 40%;
a compression set of less than 5%; and/or
a temperature resistance of −40 to +200° C.

20. The tire of claim 16, wherein the silicone foam noise reduction layer has a density of less than 60 kg/m³.

21. The tire of claim 16, wherein the silicone foam noise reduction layer has a compression set of less than 2%.

22. The tire of claim 16, wherein the silicone foam noise reduction layer has a width of 50-150 mm, a thickness of 15-30 mm, and/or extends over 90-100% of the tire inner circumference.

23. The tire of claim 16, wherein the silicone foam noise reduction layer is located centrally on the sealant layer.

24. The tire of claim 16, wherein the sealant layer is formed of a single homogeneous composition and is configured to adhere to the tread portion and noise reduction layer.

25. The tire of claim 16, wherein the sealant layer is sandwiched between the tread portion and the silicone foam noise reduction layer without intermediary.

26. The tire of claim 16, wherein the tire comprises only the sealant layer and silicone foam noise reduction layer as layers in the inner cavity of the tire.

27. The tire of claim 16, wherein the tire does not comprise a separate adhesive layer in addition to the sealant layer and the silicone foam noise reduction layer.

28. The tire of claim 16, wherein the sealant layer has a viscosity of between 50-1000 Pa*s at 100° C., a layer thickness of between 1-6 mm, and/or a tackiness of 0.1-25 N.

29. The tire of claim 16, wherein the sealant layer comprises a butyl rubber, a plasticizer and a tackifier resin.

30. A vehicle comprising a tire, the tire comprising:
a tread portion;
a bead portion; and
a sidewall portion extending between the bead portion and the tread portion, wherein the tread portion, bead portion, and sidewall portion define an inner cavity of the tire;
a sealant layer arranged on the tread portion of the tire in the inner cavity of the tire; and
a silicone foam noise reduction layer arranged on the sealant layer in the inner cavity of the tire.

31. The vehicle of claim 30, wherein the silicone foam noise reduction layer is a cellular silicone foam with an open cell structure.

32. The vehicle of claim 30, wherein the silicone foam noise reduction layer is located centrally on the sealant layer.

33. The vehicle of claim 30, wherein the sealant layer is formed of a single homogeneous composition and is configured to adhere to the tread portion and noise reduction layer.

34. The vehicle of claim 30, wherein the sealant layer is sandwiched between the tread portion and the silicone foam noise reduction layer without intermediary.

35. The vehicle of claim 30, wherein the tire comprises only the sealant layer and silicone foam noise reduction layer as layers in the inner cavity of the tire.
